(19) United States
(12) Patent Application Publication
(10) Pub. No.: US 2003/0191602 A1
(43) Pub. Date: Oct. 9, 2003

(54) Apparatus and method for measuring position of mobile robot

(75) Inventors: Yong-Kwun Lee, Seongnam-City (KR); Won Choe, Seongnam-City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon City (KR)

(21) Appl. No.: 10/207,819

(22) Filed: Jul. 31, 2002

(30) Foreign Application Priority Data
Apr. 8, 2002 (KR) 2002-19039

(51) Int. Cl. G01C 9/00; G06F 15/00; G01C 17/00; G01C 19/00

(52) U.S. Cl. 702/150

(57) ABSTRACT

An apparatus measures a position of a mobile robot. An apparatus and method to measure the position of the mobile robot is provided, in which a plurality of sensor cells are installed on a bottom surface of a work space, and the mobile robot detects installation positions of the sensor cells, thus enabling the mobile robot to precisely measure its position, moving distance and moving direction. The mobile robot position measurement apparatus has one or more sensor cells and a sensor. The sensor cells each have unique position information, and are installed in a work area of the mobile robot. The sensor is mounted to the mobile robot to obtain the position information from the sensor cells and to measure a current position of the mobile robot.

### CROSS-REFERENCE TO RELATED APPLICATIONS

This application claims the benefit of Korean Application No. 2002-19039, filed Apr. 8, 2002, in the Korean Industrial Property Office, the disclosure of which is incorporated herein by reference.

### BACKGROUND OF THE INVENTION

1. Field of the Invention

The present invention relates generally to measurement of a position of a robot, and more particularly, to an apparatus and method to measure a position of a mobile robot working while moving on a plane.

2. Description of the Related Art

Generally, robots perform various tasks in place of human beings in a variety of industry applications. For example, robots perform tasks such as welding operations and assembly operations in the field of production plants. A robot which performs welding and assembly operations is typically realized as a robotic arm. That is, the robotic arm has several joints and is fixedly installed to perform instructed tasks. For this reason, a work space of the robot arm is extremely restrictive.

Unlike the robotic arm, a mobile robot is not fixedly installed and moves relatively freely. The mobile robot is used to shift parts and working tools required for production of products to desired positions. Further, the mobile robot may perform tasks such as assembling shifted parts so as to produce products. Recently, many utilization cases of mobile robots in home applications as well as industry applications have been provided. In a home, the mobile robot performs tasks such as cleaning or shifting of objects.

In order to utilize the mobile robot in industry and home applications, the mobile robot must precisely measure its current position. Especially for the utilization of the mobile robot in industry applications, it is most important to precisely measure the position of the mobile robot so as to precisely produce products normally.

FIG. 1 is a view showing a conventional system to measure a position of a mobile robot using image information of a work area and traveling information of a mobile robot. As shown in FIG. 1, the conventional position measurement system obtains image information from a bottom of a work space 102 (i.e., work area 102a) with a camera 106 fixedly installed on a ceiling of the work space 102 of a mobile robot 114. The mobile robot 114 directly receives the image information from the camera 106 through an antenna 114a and analyzes the image information, thus determining its moving direction and moving distance.

As described above, the conventional position measurement system determines the moving direction and moving distance of the mobile robot 114 by obtaining image information through the camera 106. Accordingly, if the work area 102a is of a great width, the system requires a plurality of cameras 106. Further, it is highly possible that noise components enter the work area 102a during a transmission process of the image information, thus resulting in malfunction of the mobile robot.

FIGS. 2A and 2B are side and plan views of a conventional system of measuring the position of a mobile robot using pseudo satellites and a global positioning system (GPS) receiver. As shown in FIGS. 2A and 2B, pseudo satellites 216 are installed within a work space 212, and a GPS receiver 218 is installed outside the work space 212. The pseudo satellites 216 are devices used to generate a signal similar to a GPS satellite signal. The GPS receiver 218 installed outside the work space 212 receives a GPS signal from a GPS satellite and transmits the GPS signal to the pseudo satellites 216, thus enabling four pseudo satellites 216 to be synchronized with each other by a single GPS signal. The pseudo satellites 216 operate like a real GPS satellite by generating the same signal as the real GPS satellite signal. Installation positions of the pseudo satellites 216 become bases to measure the position of the mobile robot 214. Therefore, the installation positions of the pseudo satellites 216 must be measured very precisely. Further, the installation positions must be maintained even after the pseudo satellites 216 are installed. The mobile robot 214 moving on a bottom surface 212a of the work space 212 has a GPS receiving apparatus therein, or receives a control signal from a remote system having the GPS receiving apparatus to measure its position, thus determining a moving direction and moving distance of the mobile robot 214.

The conventional position measurement system using pseudo satellites and a GPS receiver requires the GPS receiver 218 and a plurality of pseudo satellites 216. Further, the mobile robot 214 must have an expensive GPS receiving apparatus, or at least depend on a GPS receiving apparatus of the remote system. Consequently, many costs are required to prepare the conventional position measurement system. Further, the pseudo satellites 216 must be very precisely installed and must be maintained at their installation positions, thereby causing many difficulties in managing the conventional position measurement system.

### SUMMARY OF THE INVENTION

Accordingly, it is an object of the present invention to provide an apparatus and method to measure a position of a mobile robot, in which a plurality of sensor cells are installed on a bottom surface of a work space, and the mobile robot detects installation positions of the sensor cells, thus enabling the mobile robot to precisely measure its position, moving distance and moving direction.

Another object of the present invention is to provide an apparatus and method to measure a position of a mobile robot, which satisfies requirements for both precise measurement of the position of the mobile robot and reduction of a number of used sensor cells by adjusting installation intervals of sensor cells according to a user's needs.

Additional objects and advantages of the invention will be set forth in part in the description which follows and, in part, will be obvious from the description, or may be learned by practice of the invention.

The foregoing and other objects of the present invention are achieved by providing an apparatus to measure a position of a mobile robot including one or more sensor cells and a sensor, wherein the sensor cells have unique position information and are installed in a work area of the mobile robot. The sensor is mounted to the mobile robot to measure a current position of the mobile robot by obtaining position information from the sensor cells.

The foregoing and other objects of the present invention are achieved by providing a method of measuring a position of a mobile robot including installing one or more sensor cells having unique position information in a work area of the mobile robot, and measuring a current position of the mobile robot by obtaining position information of the sensor cells through a sensor mounted to the mobile robot.

### BRIEF DESCRIPTION OF THE DRAWINGS

The above and other objects and advantages of the invention will become apparent and more appreciated from the following description of the preferred embodiments, taken in conjunction with the accompanying drawings of which:

FIG. 1 is a view showing a conventional system to measure a position of a mobile robot using image information of a work area and traveling information of the mobile robot;

FIGS. 2A and 2B are side and plan views of a conventional system to measure a position of a mobile robot using pseudo satellites and a GPS receiver;

FIG. 3A is a block diagram of an apparatus to measure a position of a mobile robot, according to an embodiment of the present invention;

FIG. 3B is a circuit diagram showing the construction of an RF tag of the position measurement apparatus of FIG. 3A;

FIG. 3C is a flowchart of a method of measuring the position of a mobile robot, according to an embodiment of the present invention;

FIGS. 4A and 4B are views showing an installation of the position measurement apparatus;

FIG. 5 is a view showing an example of installation of RF tags of the position measurement apparatus;

FIGS. 6A and 6B are views showing another installation of the position measurement apparatus;

FIG. 7 is a view showing another example of installation of the RF tags of the position measurement apparatus;

FIG. 8 is a view showing a further example of installation of the RF tags of the position measurement apparatus; and

FIG. 9 is a view showing an example of installation of a hall current sensor of the position measurement apparatus.

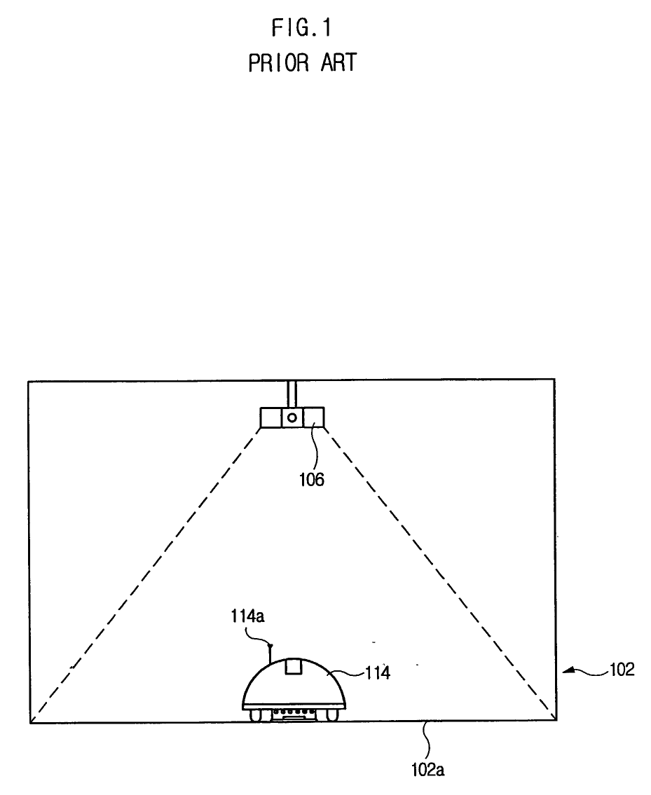

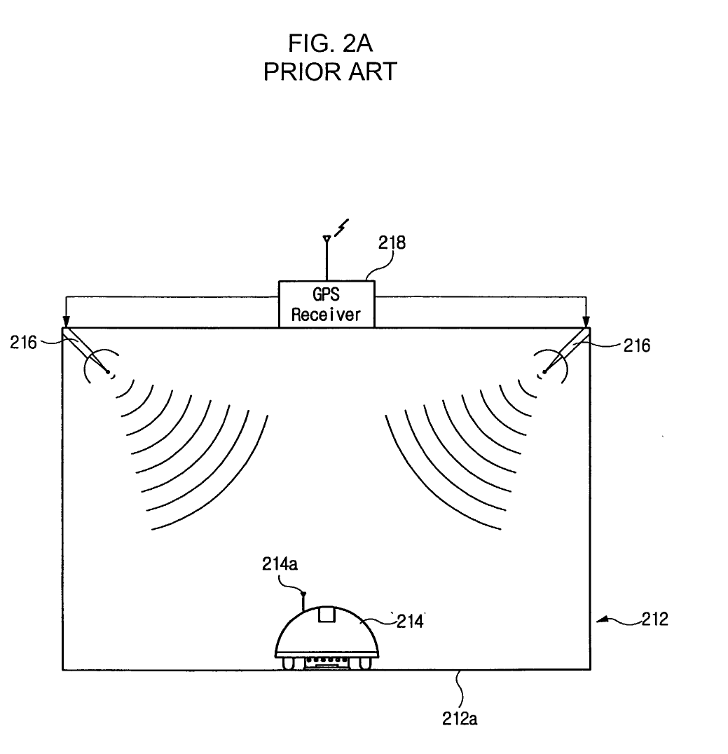

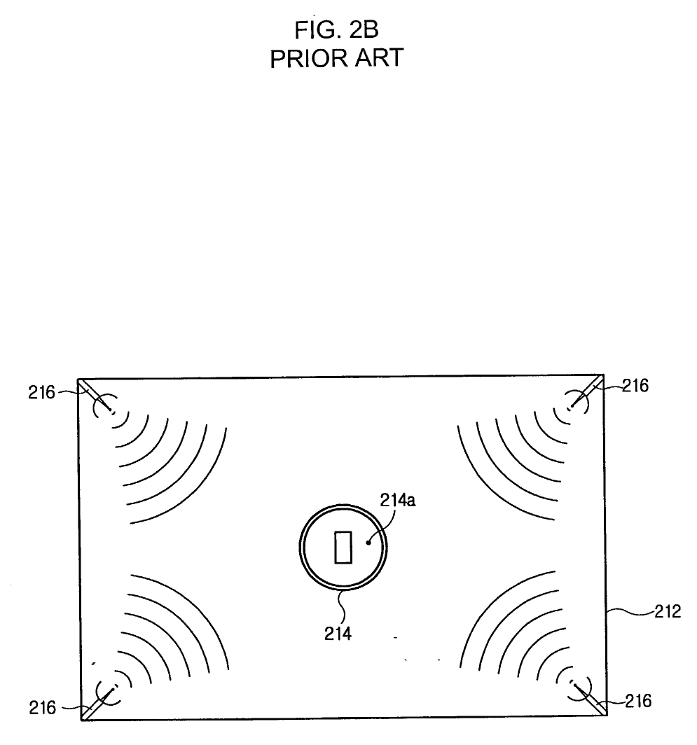

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

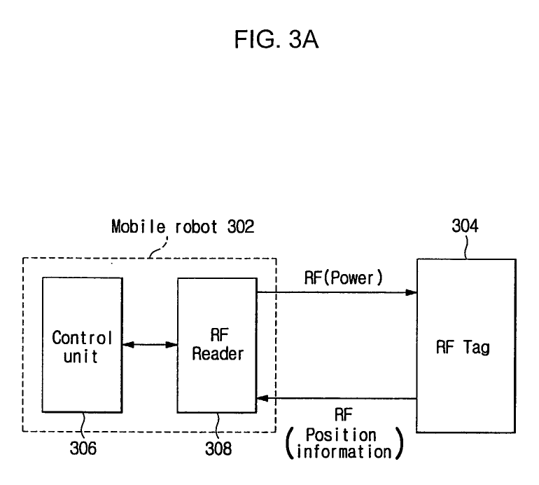

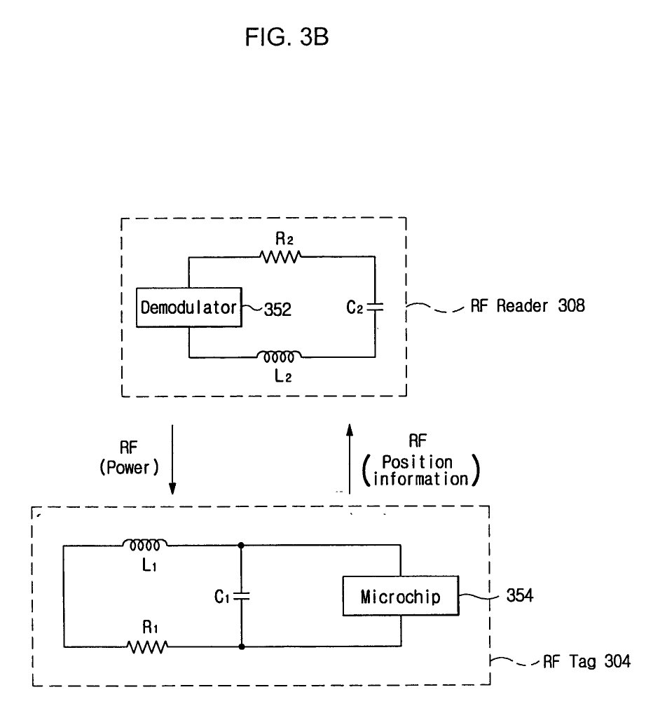

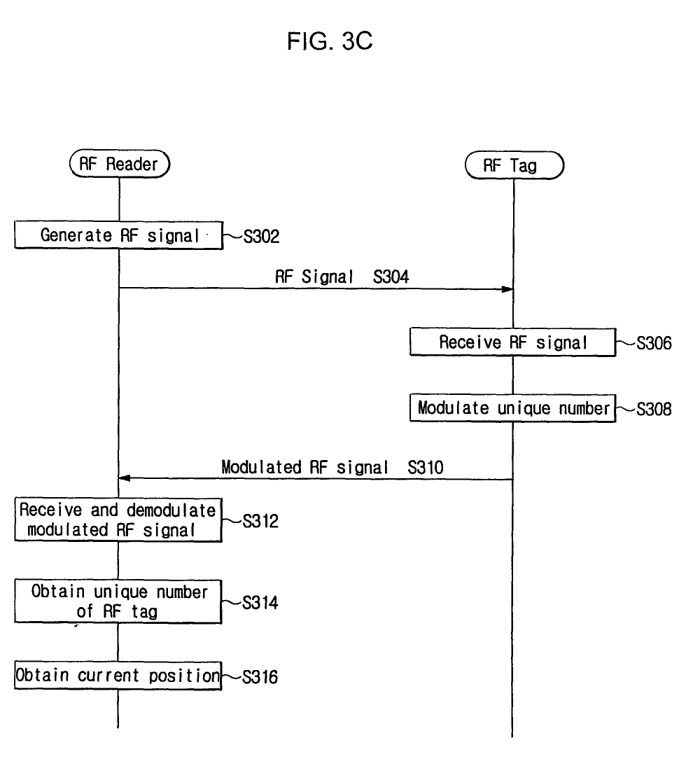

FIG. 3A is a block diagram of an apparatus to measure a position of a mobile robot according to an embodiment of the present invention. As shown in FIG. 3A, a mobile robot 302 includes a control unit 306 and an RF reader 308. The control unit 306 controls all operations of the mobile robot 302. The RF reader 308 generates an RF signal, and receives and demodulates an RF signal generated by the RF tag 304. The RF tag 304, which is a sensor cell, is assigned and stores a unique number. When the RF reader 308 generates an RF signal, the RF tag 304 uses the generated RF signal as power, and provides the stored unique number to the RF reader 308.

FIG. 3B is a circuit diagram showing the construction of the RF tag 304 of the mobile robot position measurement apparatus shown in FIG. 3A. As shown in FIG. 3B, the RF tag 304 is realized in a passive manner which does not require additional power, and uses the RF signal generated by the RF reader 308 as power. The RF tag 304 includes a resonance circuit having an inductor L1, a capacitor C1, a resistor R1, and a microchip 354. The microchip 354 has a rectifying device, a fundamental RF modulating device and a non-volatile memory formed therein (internal construction of the microchip 354 is not shown). The inductor L1 operates as an antenna to transmit/receive an RF signal. When the RF signal generated by the RF reader 308 of the mobile robot 302 is received, an alternating current (AC) voltage is induced in the inductor L1. This AC voltage is converted into a direct current (DC) voltage by the rectifying device of the microchip 354, thus enabling the capacitor C1 to be charged by the DC voltage. The RF tag 304 uses a charged voltage of the capacitor C1 as power. The non-volatile memory within the microchip 354 is used to store position information on an installation position of the RF tag 304. In this case, an electrical erasable and programmable read only memory (EEPROM) enabling both reading and writing of data, or an electrical programmable read only memory (EPROM) enabling only reading of data is employed as the non-volatile memory. The EEPROM enables both writing and reading of data, so the position information of the RF tag 304 may be freely changed if necessary. Therefore, the EEPROM provides great flexibility in utilizing the position measurement apparatus of the present invention. On the other hand, while the EPROM enables only reading of a previously stored unique number, it is inexpensive relative to the EEPROM, thereby reducing installation cost and maintenance cost of the mobile robot position measurement apparatus.

The RF reader 308 mounted to the mobile robot 302 also includes a resonance circuit having an inductor L2, a capacitor C2, and a resistor R2, and a demodulator 352. The inductor L2 functions as an antenna, and the demodulator 352 demodulates a received signal into an original signal. The RF reader 308 obtains position information stored in the RF tag 304 by generating an RF signal, receiving a signal returned from the RF tag 304 through the inductor L2, and demodulating the signal into an original signal. Position information obtained according to the above procedure is analyzed by a microcomputer within the mobile robot 302 and is used as a basis to ascertain the position of the mobile robot 302.

FIG. 3C is a flowchart of a method of measuring the position of a mobile robot. As shown in FIG. 3C, when the RF reader 308 generates and transmits an RF signal at operations S302 and S304, the RF tag 304 receives the RF signal generated by the RF reader 308 at operation S306, and uses the RF signal as power. Further, the RF tag 304 modulates a data signal of the position information stored in the RF tag 304 at operation S308, and transmits the modulated signal to the RF reader 308 through the inductor L1 at operation S310. The RF reader 308 receives and demodulates the modulated RF signal generated by the RF tag 304 at operation S312, thus obtaining the unique number of the RF tag 304 at operation S314. The unique number of the RF tag 304 represents unique position information of the RF tag 304, so the mobile robot 302 ascertains its position using the unique number.

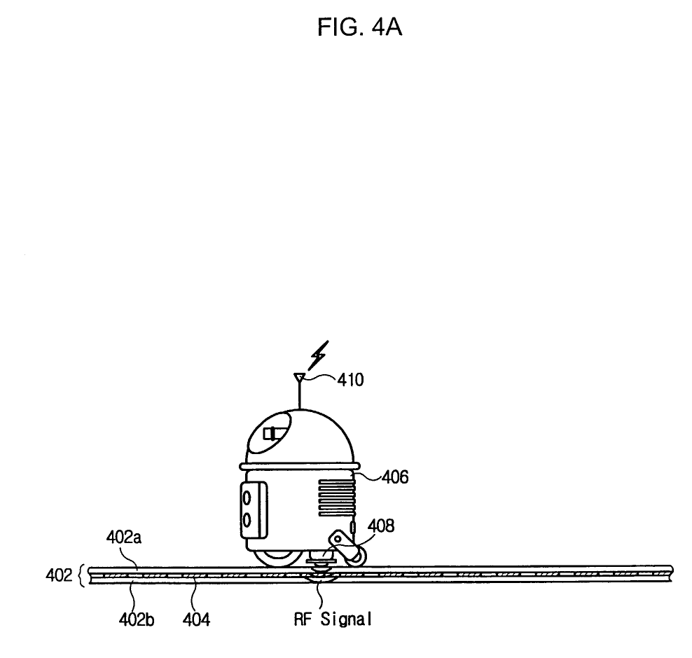

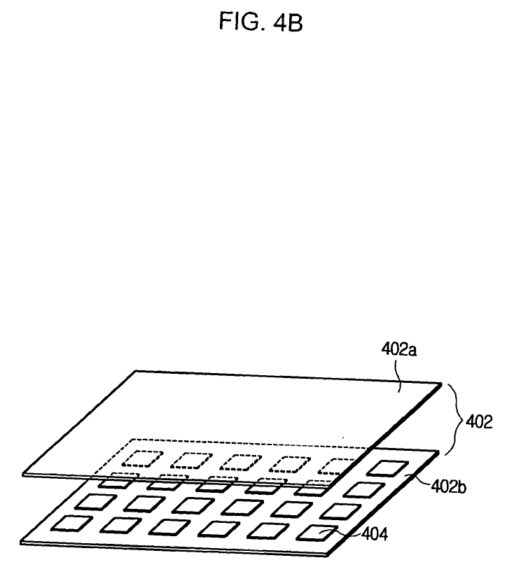

FIGS. 4A and 4B are views showing installation of the mobile robot position measurement apparatus. As shown in FIG. 4A, a work floor 402 of a work area is designed such that RF tags 404, which are sensor cells, are inserted and installed at regular intervals between first and second floor sheets 402a and 402b. The first and second floor sheets 402a and 402b are formed using plastic, polyvinyl chloride (PVC), or wood. As shown in FIG. 4B, the RF tags 404 are attached and installed at regular intervals to a surface of the second floor sheet 402b. The first floor sheet 402a is attached over the RF tags 404, thus preventing the RF tags 404 from being damaged. Generally, a work floor is previously produced to a predetermined size and constructed to be cut or extended according to a size of a work area. However, the work floor 402 of the present invention] may be installed regardless of the size of the work area. In a concrete structure without an additional work floor, the RF tags 404 are laid under the concrete at desired intervals during construction. Thus, an RF signal may easily travel through the concrete.

Referring to FIG. 4A, a mobile robot 406 performs tasks while moving on the work area in which the work floor 402 is installed. An RF reader 408, used to obtain position information of RF tags 404, is mounted to a lower portion of the mobile robot 406. The RF reader 408 generates an RF signal downwardly and then receives and reads signals returned from the RF tags 404. The signals returned from the RF tags 404 contain information on installation positions of the RF tags 404.

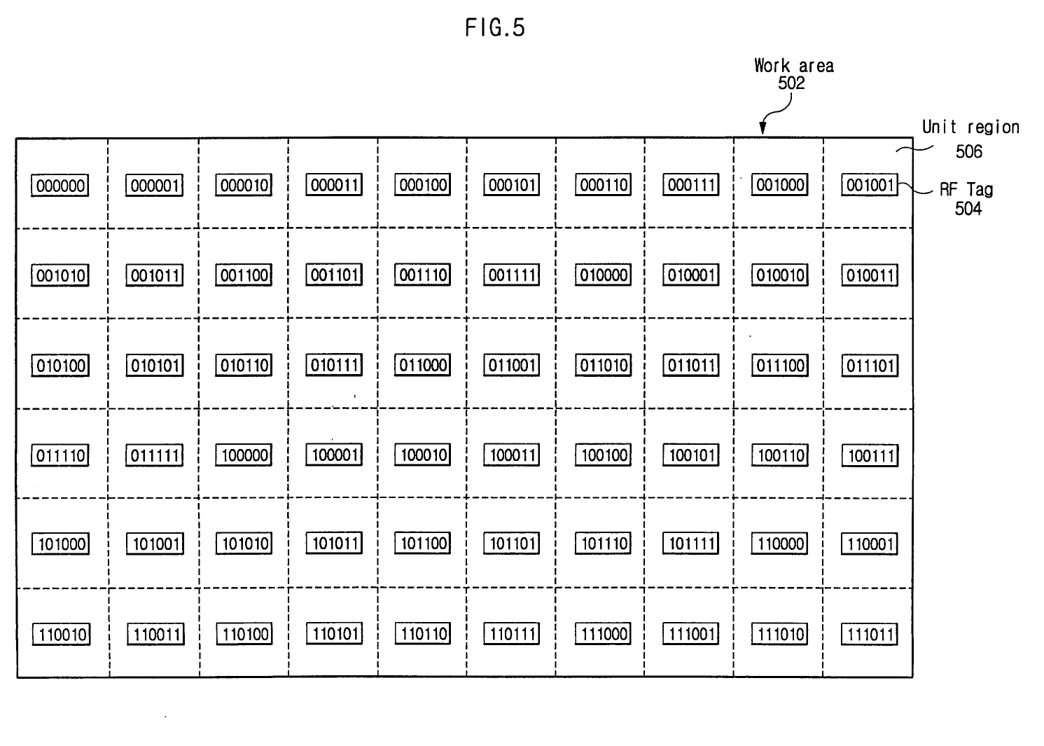

FIG. 5 is a view showing an example of installation of the RF tags of the mobile robot position measurement apparatus. Referring to FIG. 5, a plurality of RF tags 504 are installed at regular intervals in a work area 502, in which the mobile robot 406 performs tasks. Each of the RF tags 504 is assigned a unique number, which is unique position information of a corresponding RF tag 504. Each unit region partitioned with dotted lines in FIG. 5 represents a region corresponding to the assigned position information. The position information of each RF tag 504 is stored in a microchip of each RF tag 504 in a form of binary data. When the RF signal is generated by the RF reader 408 of the mobile robot 406, the mobile robot 406 measures its position by obtaining the unique number of a corresponding RF tag 504 from the corresponding RF tag 504 installed at a current position of the mobile robot 406 using the same method as shown in FIG. 4A.

Measurements of the moving direction and the moving distance of the mobile robot 406 are important. As shown in FIG. 5, position information values of neighboring RF tags 504 differ from each other, and position information values in a row are not identical to position information values in a column. Therefore, the moving direction of the mobile robot 406 is measured by analyzing the differences. Further, the moving distance of the mobile robot 406 is measured by comparing position information at a starting point and position information at a stopping point of the mobile robot 406, and using the above direction measurement method.

In FIG. 5, resolution of the work area 502 may be changed by controlling installation density of the RF tags 504. If the installation density is increased by installing more RF tags 504, the resolution of the work area 502 is increased, thus enabling the position of the mobile robot 406 to be more precisely measured. To the contrary, if the installation density is decreased by installing fewer RF tags 504, the resolution of the work area 502 is decreased, thus preventing the position of the mobile robot 406 from being precisely measured. However, a number of the installed RF tags 504 may be reduced. Accordingly, in work areas not requiring precise position measurements, the installation cost and maintenance cost may be reduced by decreasing the installation density and the number of the RF tags 504.

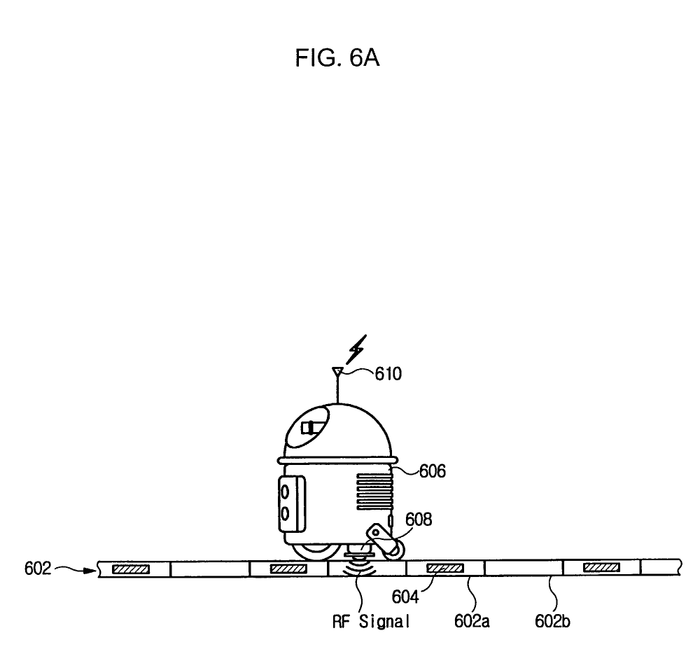

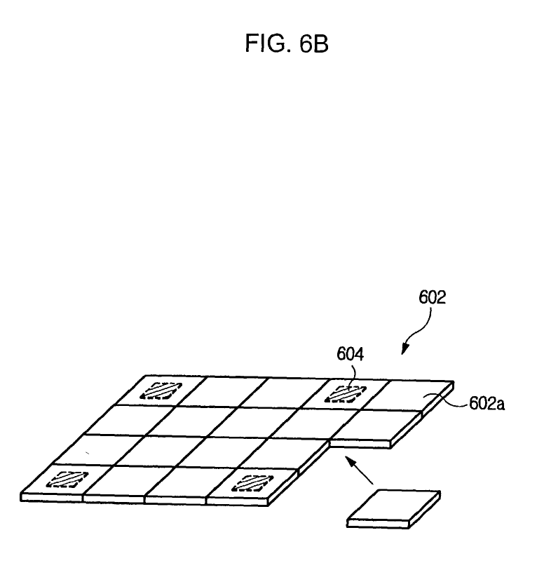

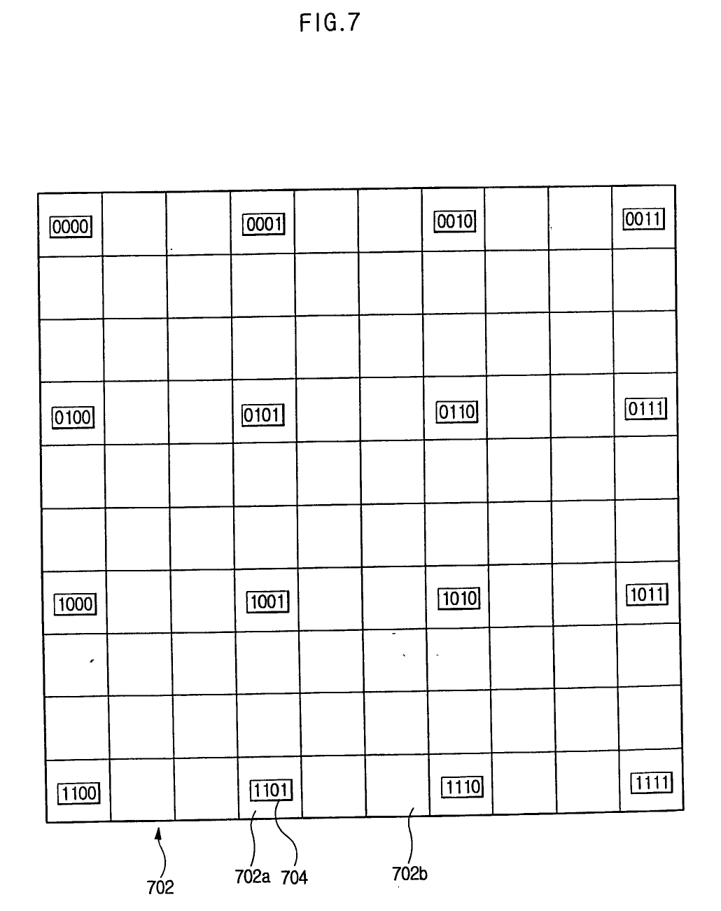

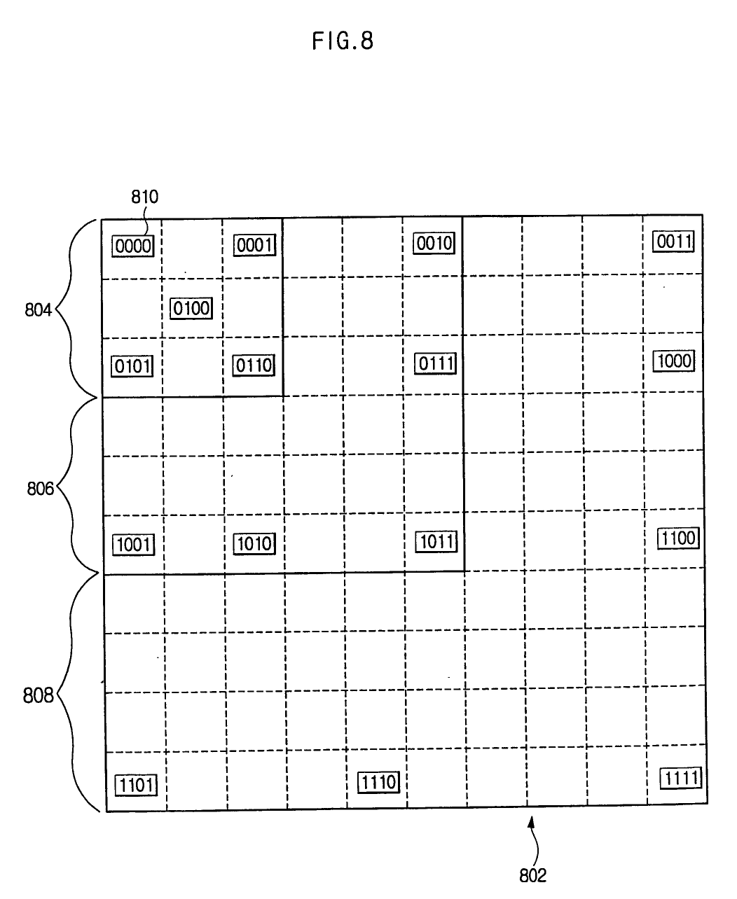

FIGS. 6A and 6B are views showing another installation of the mobile robot position measurement apparatus. Referring to FIGS. 6A and 6B, a work floor 602 of a work area is formed by connecting a plurality of unit floor modules 602a and 602b. For example, as shown in FIG. 6B, first unit floor modules 602a having an RF tag 604 and second unit floor modules 602b not having an RF tag 604 are suitably mingled and arranged, such that flexibility is granted to installation intervals of the RF tags 604. Moreover, the work floor of the present invention may be installed regardless of the size of the work area. The flexibility of the installation intervals of the RF tags 604 is described in detail with reference to FIGS. 7 and 8.

FIG. 7 is a view showing another example of installation of the RF tags of the mobile robot position measurement apparatus. Referring to FIG. 7, a work floor 702 of a work area is formed by connecting a plurality of unit floor modules 702a and 702b. That is, two pairs of unit floor modules 702b not having an RF tag 704 are successively inserted and arranged in both row and column directions between unit floor modules 702a having an RF tag 704, respectively, thus widening an interval between neighboring RF tags 704. The interval may be relatively freely changed according to the user's requirement when the work floor 702 is constructed. Thus, in applications not requiring precise position measurements of the mobile robot 406, the number of RF tags 704 may be reduced by widening the intervals between RF tags 704.

Further, even in the same work area, the flexibility in installation intervals of the RF tags may be maximized by increasing the installation density of the RF tags in a specific work region, which requires position measurements of high precision and decreasing the installation density of the RF tags in remaining work regions.

FIG. 8 is a view showing a further example of installation of the RF tags of the mobile robot position measurement apparatus. As shown in FIG. 8, in a work region 804 requiring precise position control of the mobile robot 406, the precise position of the mobile robot 406 may be measured by increasing installation density of RF tags 810. Further, in another work region 806, which does not particularly require precise position measurements of the mobile robot 406, the installation density of the RF tags 810 is relatively low. Another work region 808 not only has low working frequency of the mobile robot 406, but also does not require precise position measurements. Therefore, in the work region 808, the installation density of the RF tags 810 is further decreased. Thus, position measurements of high precision and reduction of the number of RF tags 810 may be achieved by controlling the installation density of the RF tags 810.

In the mobile robot position measurement apparatus of the present invention, if the number of RF tags to be installed is large, unique numbers with many bits must be assigned so as to discriminate respective RF tags. Thus, if the number of bits increases, the sizes of respective memories for storing the unique numbers inevitably increase. Therefore, as shown in FIGS. 7 and 8, if the installation density of the RF tags is decreased, the number of RF tags is reduced and the size of the memory of each RF tag is reduced. Therefore, inexpensive RF tags may be used to be more economical.

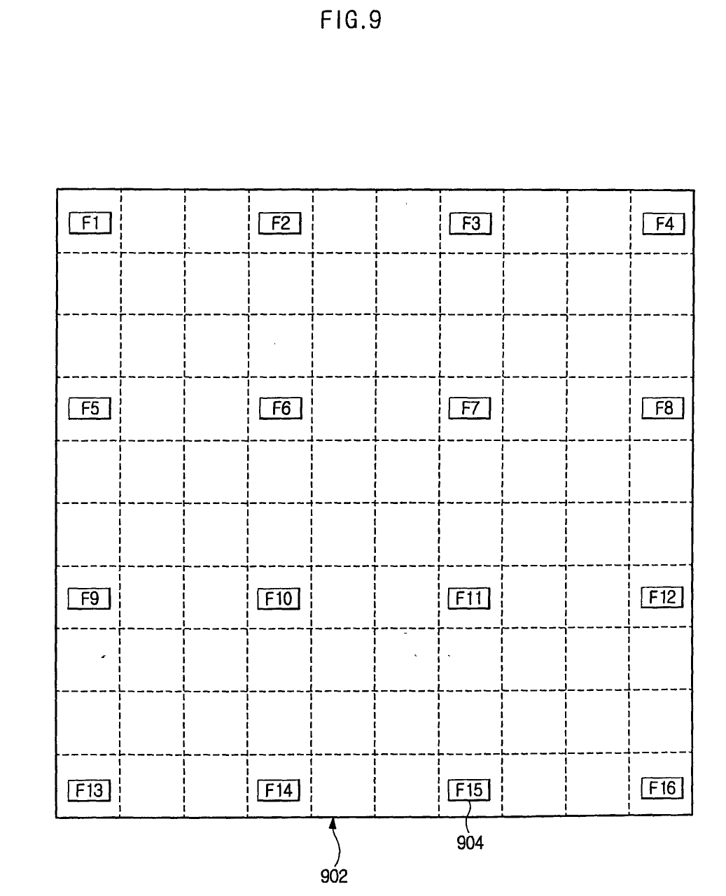

FIG. 9 is a view showing an example of installation of a hall current sensor of the mobile robot position measurement apparatus according to the present invention. A hall current sensor is a sensor using a hall effect. The hall current sensor is used to detect intensity and direction of a magnetic field of a permanent magnet using current variation of a sensor due to the magnetic field of the permanent magnet. As shown in FIG. 9, if a plurality of permanent magnets 904 are installed in a work floor 902 of a work area, and the hall current sensor (not shown) is mounted to a lower portion of the mobile robot 406 in place of the RF reader 408, the mobile robot 406 measures its current position, moving direction and moving distance using the magnetic field intensities (F) of the permanent magnets 904. Here, the magnetic field intensities of the permanent magnets 904 installed in the work floor 902 are set to be different. If the permanent magnets 904 are installed in a very wide work area with high density, a maximum magnetic field intensity of the permanent magnets may increase excessively. Therefore, the hall current sensor is used in applications in which the installation density of the permanent magnets 904 is relatively low as in the example shown in FIGS. 8 and 9. Referring to FIG. 9, a number Fxx assigned to each permanent magnet 904 represents a relative value of a magnetic field intensity of each permanent magnet 904.

As described above, the present invention provides an apparatus and method to measure a position of a mobile robot, in which a plurality of sensor cells are installed on a bottom surface of a work space, and the mobile robot detects installation positions of the sensor cells, thus enabling the mobile robot to precisely measure its position, moving distance and moving direction. Further, the present invention is advantageous in that it may satisfy requirements for both precise position measurements of the mobile robot and reduction of a number of sensor cells by adjusting installation intervals of sensor cells according to a user's needs.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An apparatus to measure a position of a mobile robot, comprising:
one or more sensor cells each having unique position information, the sensor cells being installed in a work area of the mobile robot; and
a sensor mounted to the mobile robot to obtain the position information from the sensor cells and to measure a current position of the mobile robot.

2. The position measurement apparatus according to claim 1, wherein the sensor cells are RF tags, and the sensor is an RF reader.

3. The position measurement apparatus according to claim 2, wherein the RF tags are positioned in various places throughout the work area.

4. The position measurement apparatus according to claim 1, wherein the sensor cells are permanent magnets having different magnetic field intensities, and the sensor is a hall current sensor, which generates electrical signals with intensities corresponding to the magnetic field intensities of the permanent magnets.

5. The position measurement apparatus according to claim 1, wherein the sensor cells are formed such that an installation density of the sensor cells is uniform over an entire work area.

6. The position measurement apparatus according to claim 1, wherein the sensor cells are formed such that an installation density of the sensor cells of a region requiring precise position measurement in the work area is higher than those of remaining regions in the work area.

7. A method of measuring a position of a mobile robot, comprising:
installing one or more sensor cells each having unique position information in a work area of the mobile robot; and
measuring a current position of the mobile robot by obtaining position information of the sensor cells through a sensor mounted to the mobile robot.

8. The position measurement method according to claim 7, wherein the sensor cells are RF tags, and the sensor is an RF reader.

9. The position measurement method according to claim 8, wherein the RF tags are positioned in various places throughout the work area.

10. The position measurement method according to claim 7, wherein the sensor cells are permanent magnets having different magnetic field intensities, and the sensor is a hall current sensor, which generates electrical signals with intensities corresponding to the magnetic field intensities of the permanent magnets.

11. The position measurement method according to claim 7, wherein the sensor cells are formed such that installation density of the sensor cells is uniform over the entire work area.

12. The position measurement apparatus according to claim 7, wherein the sensor cells are formed such that an installation density of the sensor cells of a region requiring precise position measurement in the work area is higher than those of remaining regions in the work area.

13. A work floor in a work area for a mobile robot, comprising:
a first floor sheet; and
one or more sensor cells each having unique position information, the sensor cells being installed on a surface of the first floor sheet.

14. The work floor according to claim 13, further comprising:
a second floor sheet attached over the sensor cells to protect the sensor cells.

15. The work floor according to claim 13, wherein the sensor cells are RF tags.

16. The work floor according to claim 15, wherein the RF tags are positioned in various places throughout the work area.

17. The work floor according to claim 13, wherein the sensor cells are permanent magnets having different magnetic field intensities.

18. The work floor according to claim 13, wherein the sensor cells are formed such that an installation density of the sensor cells is uniform over the entire work floor.

19. The work floor according to claim 13, wherein the sensor cells are formed such that an installation density of the sensor cells of a region requiring precise position measurement in the work floor is higher than those of remaining regions in the work area.

20. The work floor according to claim 13, wherein the work floor is produced according to a preset size, and used to be cut and extended to a desired size.

21. The work floor according to claim 13 or 14, wherein the first and second floor sheets are made of a flexible material.

22. A work floor in a work area for a mobile robot, comprising:
one or more first unit floor modules each having a sensor cell with unique position information; and
one or more second unit floor modules combined with the first unit floor modules.

23. The work floor according to claim 22, wherein the sensor cells are RF tags.

24. The work floor according to claim 23, wherein the RF tags are positioned in various places throughout the work area.

25. The work floor according to claim 22, wherein the sensor cells are permanent magnets having different magnetic field intensities.

26. The work floor according to claim 22, wherein the first unit floor modules are formed such that an installation density of the sensor cells of the first unit floor modules is uniform over the entire work floor.

27. The work floor according to claim 22, wherein the first unit floor modules are formed such that an installation density of the sensor cells of a region requiring precise position measurement on the work floor is higher than those of remaining regions on the work floor.

28. An apparatus to measure a position of a mobile robot, comprising:
at least one sensor cell having position information, and installed on a work floor in a work area of the mobile robot; and
a sensor mounted the mobile robot to obtain the position information from the sensor cell to thereby measure a current position, moving direction, and moving distance of the mobile robot.

29. The apparatus according to claim 28, wherein the sensor cell is an RF tag, and the sensor is an RF reader.

30. The apparatus according to claim 29, wherein a plurality of RF tags are placed at various intervals on the work floor of the work floor area.

31. The apparatus according to claim 30, wherein a resolution of the work area is increased based on a number of the plurality of RF tags to thereby enable precise measurement of the position of the mobile robot.

32. The apparatus according to claim 28, wherein the sensor cell is a permanent magnet having a magnetic field intensity, and the sensor is a hall current sensor to detect an intensity and direction of a magnetic field of the permanent magnet to thereby measure the current position, moving direction, and moving distance of the mobile robot based on the intensity of the permanent magnet.

33. A method of measuring a position of a mobile robot, comprising:
installing at least one sensor cell having position information on a work floor in a work area of the mobile robot; and
measuring a current position, moving direction, and moving distance of the mobile robot by obtaining position information of the sensor cell through a sensor mounted to the mobile robot.
